(19) United States
(12) Patent Application Publication
(10) Pub. No.: US 2006/0236577 A1
(43) Pub. Date: Oct. 26, 2006

(54) Illuminated street sign with the depiction of the honored person and with a sound reproduction apparatus

(76) Inventor: Markos Arvanitis, Paleo Faliro (GR)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/541,852

(22) PCT Filed: Jan. 12, 2004
(86) PCT No.: PCT/GR04/00001

§ 371 Date: May 25, 2006

(30) Foreign Application Priority Data
Jan. 10, 2003 (GR) 20030100008

(51) Int. Cl. G09F 7/00

(52) U.S. Cl. 40/612

(57) ABSTRACT

A street name sign depicted with a portrait of the honored person or a subject which the street was named after, including a box and a sound reproduction apparatus. The external surface of the box is made of a transparent material, and on its front part is the portrait of the honored person, or the depiction of the subject, relevant to the street name. The street name is displayed below the portrait or the depiction of the subject and the sound reproduction apparatus (7) is installed inside the box optionally with a radio receiver, a storage medium of any desired acoustic message, a loudspeaker (8) and a lighting fixture (5) powered by conventional means or by solar energy through solar cells (6) located on top of the box.

### BACKGROUND OF THE INVENTION

The present invention constitutes an improvement—amendment of the Greek Patent No. 1003494.

### FIELD OF THE INVENTION

The invention relates to a street sign consisting of a box, the external surface of which is made of a transparent material (plastic, glass etc.) whilst in its internal part a sound reproduction apparatus is located which can operate with or without a remote control.

### DESCRIPTION OF RELATED ARTS

Until today the naming of the streets, squares and other places (street and place naming), was made according to the current provisions, in honor of famous persons, of very important events and characteristics, or places of great importance etc.

In the prior art the street signs are made of a parallel flat metal upon which the street name is written. Said street signs are usually located on buildings in the corners of the streets.

### SUMMARY OF THE INVENTION

The street signs, according to the invention, have double purposes, i.e. functional and honorary. Contrary to the above described technique of construction and placement, the conventional street signs fulfill only the functional purpose, i.e. showing the name of the streets, squares, and other places and facilitating the traffic of people.

The street signs with the depiction of the honored person or with an image related to the name of the street was granted into Greek Patent No. 1003494, which are hereby incorporated by reference.

To promote the honorary purpose of the street sign as much as possible, a sound reproduction apparatus has been added to the invented street sign, which can be operated manually or by a remote control. In this way, the local authorities have the ability to provide information related to the honored person and in general to the naming of the street, or to any other subject they wish, to any interested party. It is obvious that culture and history as a whole will benefit by the present invention. In addition, due to the fact that heat is generated on the external surface of the invented street signs, caused by the lighting fixture, in places with generally low temperatures the coverage of said street signs by snow or ice will be avoided. Moreover, the present patent especially facilitates the traffic of blind and disabled people and overcomes language barriers.

### BRIEF DESCRIPTION OF THE DRAWINGS

The invention will be comprehensive to those skilled in the art, with reference to the accompanying drawings of the present specification, which show industrial preferred embodiments of the present invention.

In particular, FIG. 1 is a perspective view of the box of the street sign with a lit surface according to the invention.

FIG. 2 is a perspective view of the internal design of the box of the street sign in FIG. 1, with a lighting apparatus and a sound reproduction apparatus, and loudspeakers.

The drawings show an example of the present invention. Hereinafter, same reference numbers of the main parts of the object refer to the corresponding reference numbers of those parts in the accompanying drawings. The parts are not depicted to scale but simply in dimensions proportional to one another.

### DESCRIPTION OF THE PREFERRED EMBODIMENTS

According to a preferred embodiment of the invention, the street sign (FIG. 1) includes a box, the side 1 of which is metal to provide more resistance and being waterproof. On the side 1 of the street sign there are a general system operation switch 9, a sound volume configuration potentiometer 10, a mode control switch 11 (selection of radio, tape or MP3), a switch 12 for turning on and off a lamp and a connector pin 13 for connecting a battery to an external charger. Alternatively, on the upper external side of the box, solar cells 6 for charging the battery are located. On the front external surface 2 of the box, there is a portrait 3 of an honored person, or the depiction of a subject, corresponding to the naming of the street, whilst below the depiction the street name 4 is written. Moreover, the street number of a building could also be shown when the street sign is located in front of a specific building, whether or not the building shares the same name.

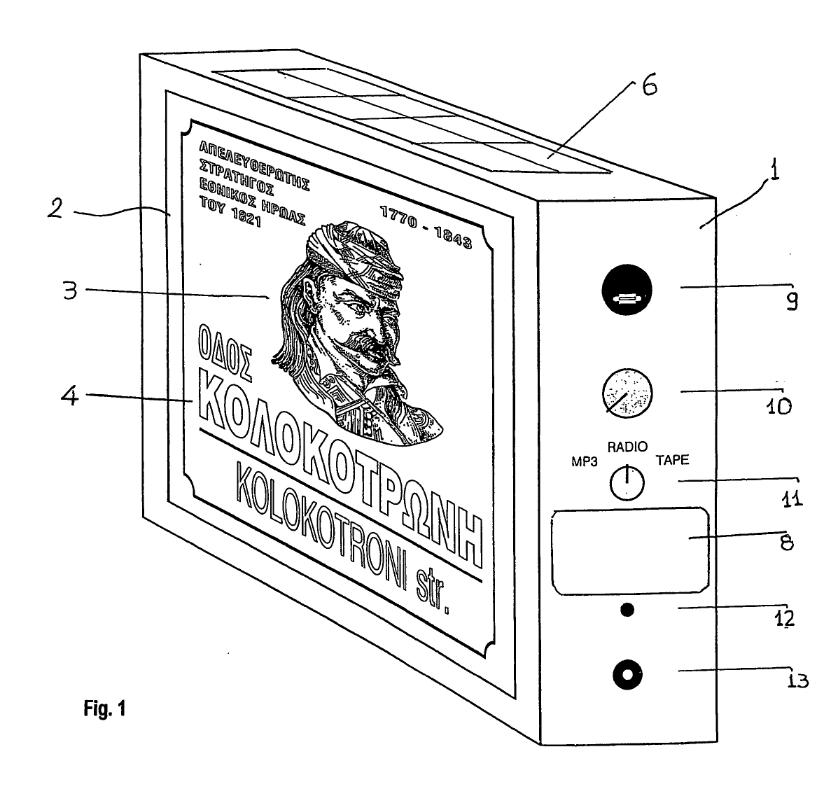

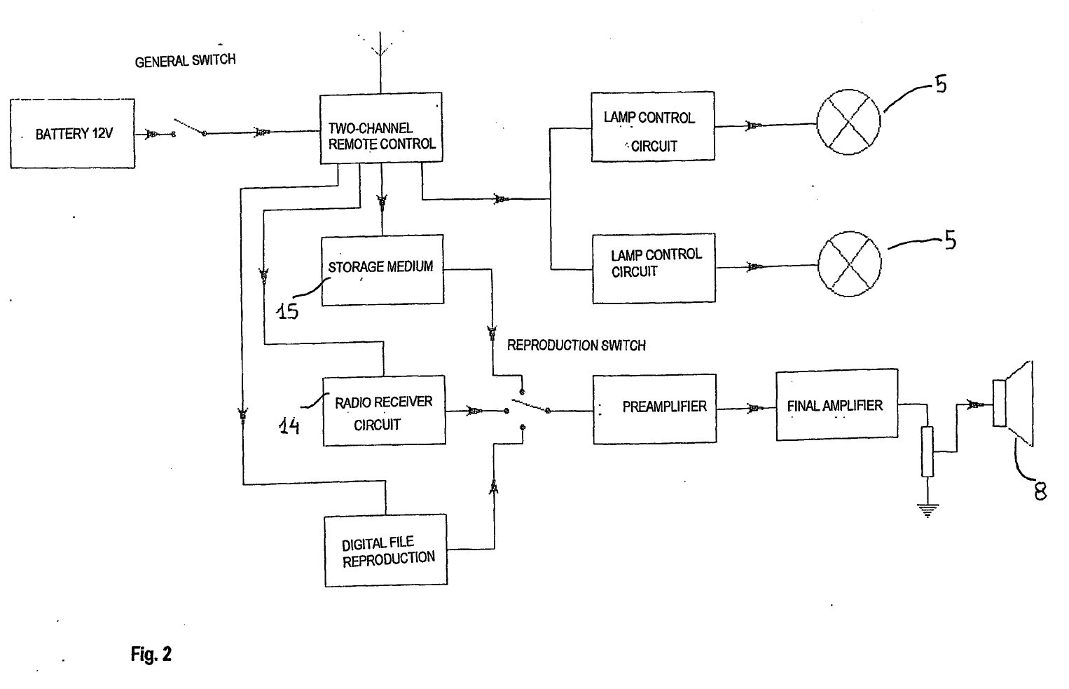

Inside the street sign (FIG. 2) a lighting fixture 5 is located to illuminate the street sign mostly at night to be easily visible by people. The lighting fixture 5 could be a typical lamp, a neon lamp or another type of lamp of a desired luminous density and electricity consumption. It is powered by the battery, which could be recharged by the connector pin 13 or by the solar cells 6.

Inside the street sign, a sound reproduction apparatus 7 is also located, which is connected to the loudspeaker 8. Alternatively, a radio receiver circuit 14 is located. Inside the sound reproduction apparatus 7, there is a storage medium 15 for storing any desired acoustic message. The sound reproduction apparatus 7 can be operated manually or by a remote control.

In this way, any interested person could find more information related to the naming of the street or in general related to the place where this street is located, or any other useful information.

It should also be noted that the object of the present invention should not be limited to the above described example. The accomplishment of this invention is also possible in other constructive ways, methods, fittings and machinery within the scope of the present specification.

1. A street name sign depicted with a portrait of the honored person or a subject which the street was named after, comprising a box and a sound reproduction apparatus, characterized in that the external surface of said box is being made of a transparent material, and the front part of the box is depicted with the portrait of the honored person, or the depiction of the subject which is relevant to the street name, whilst below said portrait or depiction the street name 4 is displayed, wherein the sound reproduction apparatus 7 is installed inside the box and has a storage medium of at least one desired acoustic message or alternatively a radio receiver circuit, a loudspeaker 8 and a lighting fixture 5 of the desired shape.

2. A street name sign, according to claim 1, characterized in that, its side 1 is metal to provide more resistance and being waterproof, on which side a general system operation switch 9, a sound volume configuration potentiometer 10, a mode control switch 11, a switch 12 for turning on and off the lighting fixture 5 and also a connector pin 13, are fixed.

3. A street name sign, according to claim 1, wherein the lighting fixture 5 of desired shape is located in the box, and a power supply of the lighting fixture 5 is a battery powered by electric current supply or by the solar cells 6 located on top of the box.

4. A street name sign, according to claim 1, wherein the sound reproduction apparatus is operated manually or by a remote control.
